(19) United States
(12) Patent Application Publication
(10) Pub. No.: US 2016/0093963 A1
(43) Pub. Date: Mar. 31, 2016

(54) ELECTRICAL CONNECTOR SYSTEM

(71) Applicant: FCI AMERICAS TECHNOLOGY LLC, Carson City, NV (US)

(72) Inventor: Michael K. STRECKEWALD, Etters, PA (US)

(21) Appl. No.: 14/785,006

(22) PCT Filed: Apr. 14, 2014
(86) PCT No.: PCT/US2014/033942

§ 371 Date: Oct. 16, 2015

Related U.S. Application Data
(60) Provisional application No. 61/813,351, filed on Apr. 18, 2013.

(51) Int. Cl. H01R 12/70; H01R 13/405; H01R 4/48

(52) U.S. Cl. CPC H01R 12/7076; H01R 4/48; H01R 13/405

(57) ABSTRACT

An electrical connector system can include a first electrically conductive contact having a first contact body, a first contact mating end that extends from the first contact body, and a first contact mounting end that extends from the first contact body. The first contact mounting end can be configured to be electrically connected to a first complementary electrical component. The system can further include an interposer having a first interposer mating end and a second interposer end opposite the first interposer mating end. The second interposer end can be configured to be placed in electrical communication with a second complementary electrical component. The first electrically conductive contact can be configured to mate at its first mating contact end to the first interposer mating end so as to place the first electrically conductive contact in electrical communication with the interposer.

### BACKGROUND

Electrical connectors typically include a connector housing that supports a plurality of electrical contacts that each defines a mounting end configured to be mounted onto a first electrical component, such as a substrate that can be provided in the form of a printed circuit board, and a mating end that is configured to mate with a second electrical component so as to place the first and second electrical components in electrical communication with each other. A connector system that includes two electrical connectors can be employed to electrically connect two PCBs. In certain cases it may be desirable to have a connector system that allows movement of one or both of the PCBs while maintaining electrical continuity.

### SUMMARY

In an embodiment, an electrical connector system can include a first electrically conductive contact having a first contact body, a first contact mating end that extends from the first contact body, and a first contact mounting end that extends from the first contact body. The first contact mounting end can be configured to be electrically connected to a first complementary electrical component. The system can further include an interposer having a first interposer mating end and a second interposer end opposite the first interposer mating end. The second interposer end can be configured to be placed in electrical communication with a second complementary electrical component. The first electrically conductive contact can be configured to mate at its first mating contact end to the first interposer mating end so as to place the first electrically conductive contact in electrical communication with the interposer.

Also disclosed is a method of electrically connecting a first electrical component to a second electrical component with an electrical connector system having an interposer, a first electrically conductive contact, and a second electrically conductive contact. The method can comprise the steps of moving the first electrically conductive contact toward a first interposer mating end defined by the interposer such that a first contact mating end of the first electrically conductive contact mates with the first interposer mating end to thereby place the first electrically conductive contact in electrical communication with the interposer; moving the second electrically conductive contact toward a second interposer mating end defined by the interposer such that a second contact mating end of the second electrically conductive contact mates with the second interposer mating end to thereby place the second electrically conductive contact in electrical communication with the interposer; mounting the first electrically conductive contact to a first electrical component; and mounting the second electrically conductive contact to a second electrical component.

### BRIEF DESCRIPTION OF THE DRAWINGS

The foregoing summary, as well as the following detailed description of an example embodiment of the application, will be better understood when read in conjunction with the appended drawings, in which there is shown in the drawings example embodiments for the purposes of illustration. It should be understood, however, that the application is not limited to the precise arrangements and systems shown. In the drawings:

FIG. 1A is a perspective view of an electrical connector system electrically connecting a first complementary electrical component to a second complementary electrical component, the electrical connector system including an interposer, a first electrical contact mated with the interposer and the first complementary electrical component, and a second electrical contact mated with the interposer and the second complementary electrical component;

FIG. 1B is a top cross-sectional view of the electrical connector system shown in FIG. 1A;

FIG. 1C is a top cross-sectional view of the electrical connector system shown in FIG. 1A with the first and second electrical contacts pivoted relative to the interposer;

FIG. 2 is a schematic view of an electrical contact including a body, a contact mating end, and a spring that couples the contact mating end to the body;

FIG. 3 is a schematic view of an electrical connector system in accordance with another embodiment, the electrical connector system including an interposer having opposing ball joints, and first and second electrical contacts each having a mating end that defines a socket that receives a respective ball joint of the interposer; and

FIG. 4 is a schematic view of an electrical connector system in accordance with another embodiment, the electrical connector system including an interposer having opposing sockets that are defined by respective inner surfaces of the interposer, each inner surface defining a groove, the electrical connector system further including first and second electrical contacts each having a mating end that defines a pin that is received by a respective socket of the interposer.

### DETAILED DESCRIPTION OF ILLUSTRATIVE EMBODIMENTS

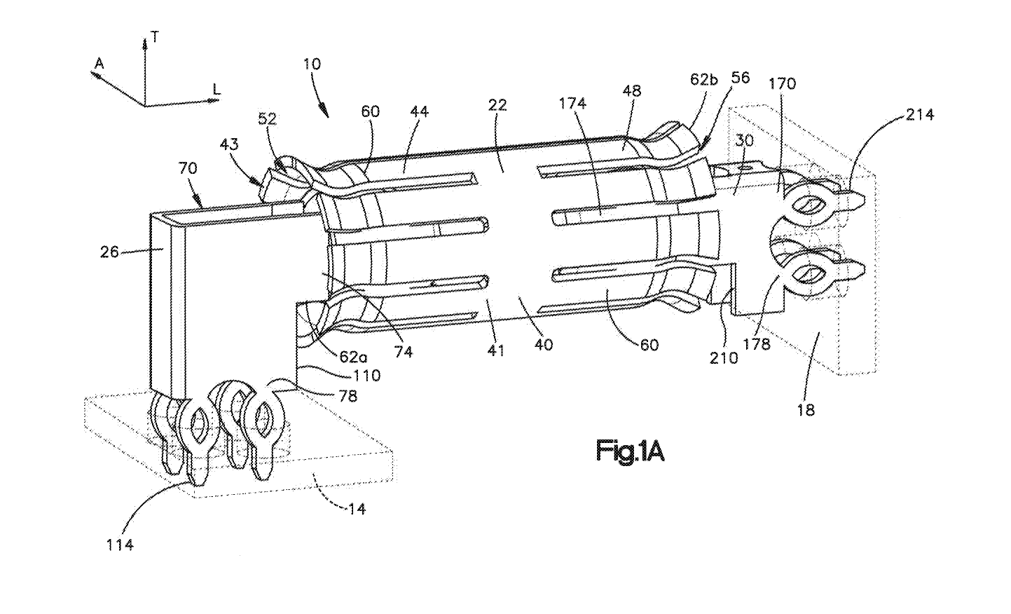

In reference to FIGS. 1A-1C, an electrical connector system 10 can be configured to electrically connect a first complementary electrical component 14 to a second complementary electrical component 18 such that at least one of the complementary electrical components 14 and 18 is capable of moving relative to the other while maintaining electrical continuity. In the illustrated embodiment, the first and second complementary electrical components 14 and 18 are printed circuit boards (PCBs). It should be appreciated, however, that the electrical components 14 and 18 can have any configuration as desired.

As shown in FIGS. 1A-1C, the electrical connector system 10 can include an interposer 22, a first electrically conductive contact 26 configured to mate with the interposer 22, and a second electrically conductive contact 30 configured to mate with the interposer 22 such that the interposer 22 and the first and second electrically conductive contacts 26 and 30 are placed in electrical communication with each other. One or both of the electrically conductive contacts 26 and 30 can be configured such that when they are mated with the interposer 22, they can pivot and/or translate relative to the interposer 22. In this way, the electrical connector system 10 allows for movement of one or both of the electrical components 14 and 18 relative to each other. While the first and second electrically conductive contacts 26 and 30 are illustrated without a dielectric housing, it should be appreciated that the contacts 26 and 30 can be housed within a dielectric housing as desired.

As shown in FIGS. 1A and 1B, the interposer 22 includes an interposer body 40 that is elongate along a longitudinal or first direction L and defines a first interposer mating end 44 and a second interposer end such as a second interposer mating end 48 that is spaced from the first interposer mating end 44 along the first direction L. The interposer body 44 can further define a width along a lateral or second direction A and a height along a transverse or third direction T. The interposer body 40 can be configured as a sleeve 41 that defines a central axis C that extends from the first interposer mating end 44 to the second interposer mating end 48. The sleeve 41 can define a channel 43 that extends from the first interposer mating end 44 to the second interposer mating end 48. It should be appreciated, however, that the channel 43 can be interrupted as desired. For example, the sleeve can be configured such that each interposer mating end 44 and 48 defines a respective channel. The interposer body 40 can be configured such that the first and second interposer mating ends 44 and 48 are aligned along the first direction and are parallel to each other. It should be appreciated, however, that in some embodiments, the first and second interposer mating ends 44 and 48 can be offset with respect to each other or can be perpendicular to each other as desired. The interposer 22 can be electrically conductive and can further include an outer insulative layer as desired. It should be appreciated, however, that the interposer 22 can be made of any materials as desired so long as the interposer can electrically connect the first electrical contact 26 to the second electrical contact 30.

With continued reference to FIGS. 1A and 1B, the first interposer mating end 44 can include a first inner surface 50 that defines a first socket 52 and the second interposer mating end 48 can include a second inner surface 54 that defines a second socket 56. The first and second interposer mating ends 44 and 48 can be expandable such that the first and second sockets 52 and 56 expand as the first and second sockets 52 and 56 receive respective contact mating ends of the first and second electrical contacts 26 and 30. As shown, the first and second interposer mating ends 44 and 48 each can include a plurality of flexible fingers 60 that are configured to flex as the contact mating ends are received by the first and second interposer mating ends 44 and 48. As shown in FIG. 1A, the flexible fingers 60 can flare radially outward at their ends 62a and 62b, respectively. The flared ends 62a and 62b allow for easier location of the contact mating ends by the first and second interposer mating ends 44 and 48. It should be appreciated, however, that in some embodiments, the first and second interposer mating ends 44 and 48 can be rigid such that the interposer mating ends 44 and 48 do not flex during mating.

With continued reference to FIGS. 1A-1C, the first electrically conductive contact 26 can be configured as a power contact and can have a first contact body 70, a first contact mating end 74 that extends from the first contact body 70, and a first contact mounting end 78 that extends from the first contact body 70. The first contact mounting end 78 can be configured to be electrically connected to the first PCB 14. The first electrically conductive contact 26 can be configured to mate at its first contact mating end 74 to the first interposer mating end 44 so as to place the first electrically conductive contact 26 in electrical communication with the interposer 22, As shown in FIG. 1B, the first contact mating end 74 can define a first outer cross-sectional dimension D₁ along a select direction that is perpendicular to the first direction and the first socket 52 can define a cross-sectional dimension D₂ along the select direction that is less than the first outer cross-sectional dimension D₁. First contact mating end 74 should define outer surfaces that are greater than D₂. Such dimensioning can ensure a secure coupling between the first contact mating end 74 and the first interposer mating end 44. It should be appreciated, however, that the first contact mating end 74 and the first interposer mating end 44 can have any dimensions as desired.

As shown in FIG. 18, the first contact mating end 74 can be compressible such that the first contact mating end 74 compresses as it is received in the first socket 52. As shown, the first contact mating end 74 can define first and second cantilevered beams 90 and 94 that extend from the first contact body 70 such that the first and second cantilevered beams 90 and 94 are spaced from each other along a direction that is perpendicular to the first direction. At least one or both of the first and second cantilevered beams 90 and 94 can compress toward the other of the first and second cantilevered beams 90 and 94 as the first contact mating end 74 is inserted into the first socket 52. At least one or both of the first and second cantilevered beams 90 and 94 can define a rounded outer surface 98 that protrudes away from the other. As shown in FIG. 1B, each rounded outer surface 98 can define a portion of a sphere. It should be appreciated, however, that the first contact mating end 74 can have other configurations. For example, the first contact mating end 74 can be spherically shaped and can include slits that allow it to compress.

As shown in FIGS. 1B and 1C, the rounded outer surfaces 98 of the cantilevered beams 90 and 94 can bear against the first inner surface 50 when the first contact mating end is disposed in the first socket 52. As shown in FIG. 1C, the first contact mating end 74 is configured to be pivotable in the first socket 52 relative to the interposer 22. Furthermore, the first contact mating end 74 is configured to be translatable in the first socket 52 relative to the interposer 22 along a direction of translation toward and away from the second interposer mating end 48. The first contact mating end 74 can be polyaxially pivotable or can be pivotable within a select plane as desired. As shown in FIG. 1B, the first contact mating end 74 can be pivotable about a centroid C₁ of the cantilevered beams 90 and 94. Therefore, because the first contact mating end 74 can translate within the first socket 52 in the L direction, the centroid C₁ will also translate within the first socket 52. It should be appreciated, however, that the first contact mating end 74 can be configured to be pivotable but not translatable with respect to the interposer 22 or translatable but not pivotable with respect to the interposer 22, as desired.

As shown in FIG. 1A, the first contact body 70 can define a stop surface 110 that is aligned with the first interposer mating end 44 along the direction of translation, such that the stop surface 110 is configured to abut the first interposer mating end 44 no as to limit translation of the first contact mating end 74 with respect to the interposer 22 toward the second interposer mating end 48. The abutment of the stop surface 110 and the first interposer mating end 44 can prevent translation of the first contact mating end 74 with respect to the interposer 22 toward the second interposer mating end 48.

With continued reference to FIG. 1A, the first contact mating end 74 can be oriented substantially perpendicular to the first contact mounting end 78. As shown, the first contact mounting end 78 can be configured as press-fit tails 114 that extend form the first body 70. The press-fit tails can be surface mounted, for instance soldered, welded or the like to the PCB 14. It should be appreciated, however, that the first contact mating end 74 can have other orientations, as desired, For example, the first contact mating end 74 can be oriented substantially parallel to the first contact mounting end 78, as desired.

With continued reference to FIGS. 1A-1C, the second electrically conductive contact 30 can be configured as a power contact and can have a second contact body 170, a second contact mating end 174 that extends from the second contact body 170, and a second contact mounting end 178 that extends from the second contact body 170. The second contact mounting end 178 can be configured to be electrically connected to the second PCB 18. The second electrically conductive contact 30 can be configured to mate at its second contact mating end 174 to the second interposer mating end 48 so as to place the second electrically conductive contact 30 in electrical communication with the interposer 22. As shown in FIG. 1B, the second contact mating end 174 can define a third outer cross-sectional dimension D₃ along a select direction that is perpendicular to the first direction and the second socket 56 can define a cross-sectional dimension D₄along the select direction that is less than the third outer cross-sectional dimension D₃. Second contact mating end 174 should define outer surfaces that are greater than D₄. Such dimensioning can ensure a secure coupling between the second contact mating end 174 and the second interposer mating end 48. It should be appreciated, however, that the second contact mating end 174 and the second interposer mating end 48 can have any dimensions as desired.

As shown in FIG. 1B, the second contact mating end 174 can be compressible such that the second contact mating end 174 compresses as it is received in the second socket 56. As shown, the second contact mating end 174 can define third and fourth cantilevered beams 190 and 194 that extend from the second contact body 170 such that the third and fourth cantilevered beams 190 and 194 are spaced from each other along a direction that is perpendicular to the first direction. At least one or both of the third and fourth cantilevered beams 190 and 194 can compress toward the other of the third and fourth cantilevered beams 190 and 194 as the second contact mating end 174 is inserted into the second socket 56. At least one or both of the third and fourth cantilevered beams 190 and 194 can define a rounded outer surface 198 that protrudes away from the other, As shown in FIG. 1B, each rounded outer surface 198 can define a portion of a sphere. It should be appreciated, however, that the second contact mating end 174 can have other configurations. For example, the first contact mating end 174 can be spherically shaped and can include slits that allow it to compress.

As shown in FIGS. 1B and 1C, the rounded outer surfaces 198 of the cantilevered beams 190 and 194 can bear against the second inner surface 54 when the second contact mating end is disposed in the second socket 56. As shown in FIG. 1C, the second contact mating end 174 is configured to be pivotable in the second socket 56 relative to the interposer 22, Furthermore, the second contact mating end 174 is configured to be translatable in the second socket 56 relative to the interposer 22 along a direction of translation toward and away from the first interposer mating end 44. The second contact mating end 174 can be polyaxially pivotable or can be pivotable within a select plane or planes as desired. As shown in FIG. 1B, the second contact mating end 174 can be pivotable about a centroid C₂ of the cantilevered beams 190 and 194. Therefore, because the second contact mating end 174 can translate within the second socket 56 in the L direction, the centroid C₂ will also translate within the second socket 56. It should be appreciated, however, that the second contact mating end 174 can be configured to be pivotable but not translatable with respect to the interposer 22 or translatable but not pivotable with respect to the interposer 22, as desired.

As shown in FIG. 1A, the second contact body 170 can define a stop surface 210 that is aligned with the second interposer mating end 48 along the direction of translation, such that the stop surface 210 is configured to abut the second interposer mating end 48 so as to limit translation of the second contact mating end 174 with respect to the interposer 22 toward the first interposer mating end 44. The abutment of the stop surface 210 and the second interposer mating end 48 can prevent translation of the second contact mating end 174 with respect to the interposer 22 toward the first interposer mating end 44.

With continued reference to FIG. 1A, the second contact mating end 174 can be oriented substantially parallel to the second contact mounting end 178. As shown, the second contact mounting end 178 can be configured as press-fit tails 214 that extend from the second body 170. The press-fit tails can be surface mounted, for instance soldered, welded or the like to the PCB 18. It should be appreciated, however, that the second contact mating end 174 can have other orientations, as desired. For example, the second contact mating end 174 can be oriented substantially perpendicular to the second contact mounting end 178, as desired.

As shown in FIG. 1C, the electrical connection between the first and second electrical contacts 26 and 30 and the interposer 22 can be maintained as the first and second mating ends 74 and 174 pivot relative to the interposer 22. Therefore, a central axis C₄ of the first electrical contact 26 can be offset with respect to a central axis C₅ of the second electrical contact 30 by a distance H, along a direction such as the lateral or transverse directions when the contacts 26 and 30 are mated with the interposer. Therefore, the system 10 can allow for movement between the first and second PCBs 14 and 18 relative to each other in at least the lateral and transverse directions.

In operation, the first contact mating end 74 of the first electrically conductive contact 26 can be mated with the first interposer mating end 44 and the second contact mating end 174 of the second electrically conductive contact 30 can be mated with the second interposer mating end 48. In particular, at least one of the interposer 22 and the first electrical contact 26 can be moved toward the other such that the first contact mating end 74 is received by the first socket 52. As the first contact mating end 74 is being received by the first socket 52, the first contact mating end 74 can compress (e.g. the cantilevered beams 90 and 94 move toward each other) until the first contact mating end 74 is fully received by the first socket 52. Similarly, at least one of the interposer 22 and the second electrical contact 30 can be moved toward the other such that the second contact mating end 174 is received by the second socket 56. As the second contact mating end 174 is being receive by the second socket 56, the second contact mating end 174 can compress (e.g. the cantilevered beams 190 and 194 move toward each other) until the second contact mating end 174 is fully received by the second socket 56. The first contact mounting ends 78 can then be mounted to the first PCB 14 and the second contact mounting ends 178 can be mounted to the second PCB 18. The system 10 allows the first and second PCBs 14 and 18 to move relative to each other while maintaining an electrical connection. It should be appreciated, however, that the system 10 and PCBs 14 and 18 can be assembled in any particular order. For example, the first and second electrical contacts 26 and 30 can be first mounted to the PCBs 14 and 18 and then mated with the interposer 22.

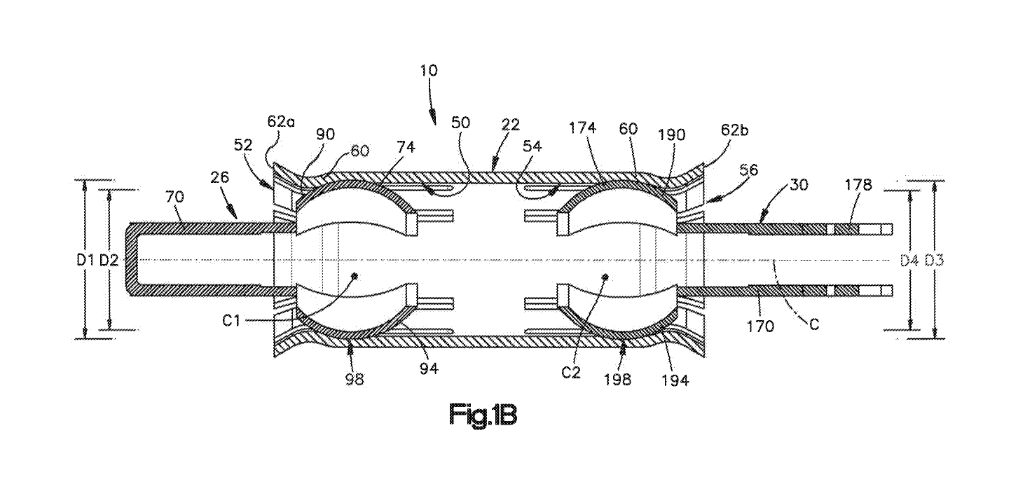

Now in reference to FIG. 2, the electrical contacts 26 and 30 can be configured to include a spring element that allows for movement of the contact mating end relative to the contact body. As shown in FIG. 2, an electrically conductive contact 226 can include a contact body 230, a contact mating end 234, and a spring element 238 that connects the contact body 230 to the contact mating end 234. The spring element 238 can be resiliently compressible as the contact mating end 234 translates toward the contact body 230. The spring element 238 can also be resiliently extendable as the contact mating end 234 translates toward the interposer mating end. It should be appreciated, that the contact 226 can include any of the features of the electrical contacts 26 and 30 and that the spring element 238 can have other configurations. For example, while, the spring element is configured as a helical spring in the illustrated embodiment, the spring element 238 can be configured as a biasing member.

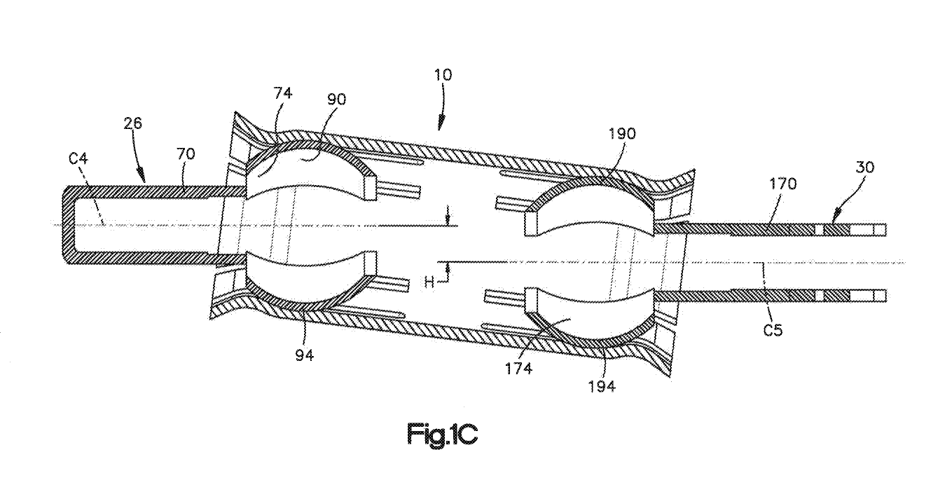

Now in reference to FIG. 3, the electrical connector system can be configured such that the mating ends of the electrical contacts define sockets and the mating ends of the interposer define ball joints. As shown in FIG. 3, an electrical connector system 410 can include an interposer 422, a first electrically conductive contact 426 mated with the interposer 422, and a second electrically conductive contact 430 mated with the interposer 422. The first and second electrically conductive contacts 426 and 430 can be pivotable and/or translatable with respect to the interposer 422 when the first and second electrically conducts 426 and 430 have been mated with the interposer 422.

As shown in FIG. 3, the interposer 422 can include an interposer body 440 that is elongate along the longitudinal direction L and defines a first interposer mating end 444 and a second interposer end such as a second interposer mating end 448 that is spaced from the first interposer mating end 444 along the first direction L. The first and second interposer mating ends 444 and 448 can be configured as ball joints 450. The ball joints 450 can be configured to be received by respective sockets defined by the electrically conductive contacts 426 and 430.

As shown in FIG. 3, the first electrically conductive contact 426 can include a first contact mating end 474 and the second electrically conductive contact 430 can include a second contact mating end 478. The first and second contact mating ends 474 and 478 can each define a socket 484 that is configured to receive a respective ball joint 450 of the interposer 422 to thereby electrically connect the first and second electrically conductive contacts 426 and 430 to the interposer 422. The sockets 484 can be configured substantially similar to the sockets 52 and 56 of the interposer 22. That is, the sockets 484 can each include a plurality of flexible fingers that flex outwardly as the sockets 484 receive the ball joints 450.

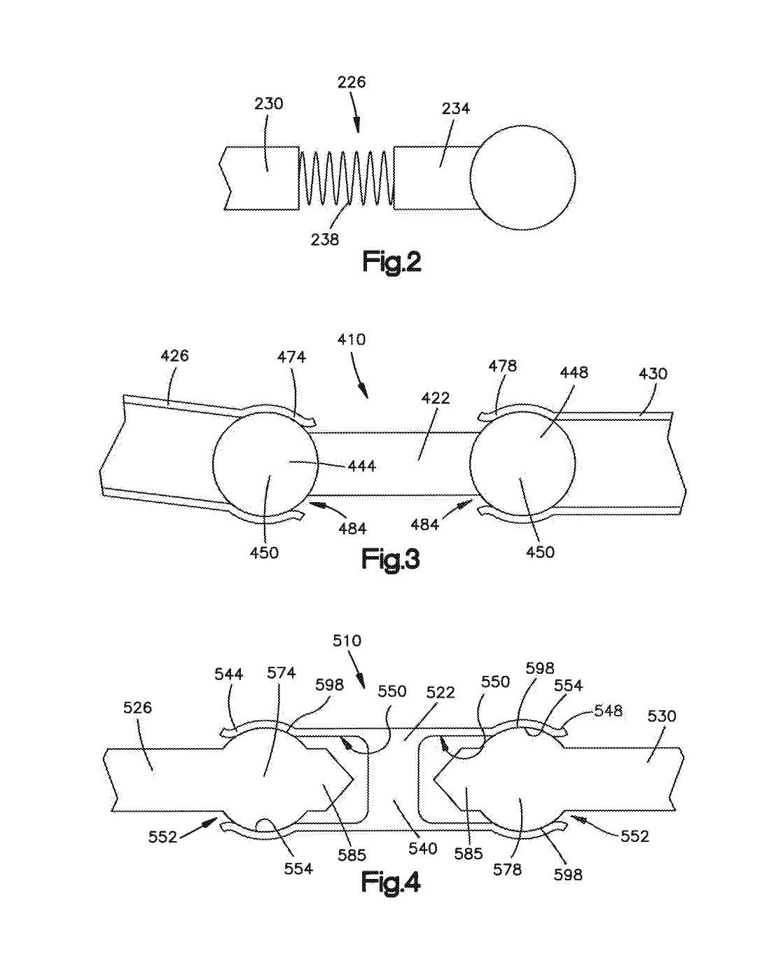

In reference to FIG. 4, the electrical connector system can be configured such that the mating ends of the electrical contacts define pins and the mating ends of the interposer define respective sockets. As shown in FIG. 4, an electrical connector system 510 can include an interposer 522, a first electrically conductive contact 526 mated with the interposer 522, and a second electrically conductive contact 530 mated with the interposer 522. The first and second electrically conductive contacts 526 and 530 can be pivotable and/or translatable with respect to the interposer 522 when the first and second electrically conductive contacts 526 and 530 have been mated with the interposer 522.

As shown in FIG. 4, the interposer 522 can include an interposer body 540 that is elongate along the longitudinal direction L and defines a first interposer mating end 544 and a second interposer end such as a second interposer mating end 548 that is spaced from the first interposer mating end 544 along the first direction L. The first and second interposer mating ends 544 and 548 can each include an inner surface 550 that defines a socket 552. Each inner surface 550 can at least partially define a radial groove 554 that is configured to receive a portion of a respective contact mating end. The sockets 552 can be configured to be received by respective pins defined by the electrically conductive contacts 526 and 530.

As shown in FIG. 4, the first electrically conductive contact 526 can include a first contact mating end 574 and the second electrically conductive contact 530 can include a second contact mating end 578. The first and second contact mating ends 574 and 578 can each define a pin 585 that is configured to be received by a respective socket 552 of the interposer 522 to thereby electrically connect the first and second electrically conductive contacts 526 and 530 to the interposer 522. Each pin 585 can define a pair of rounded outer surfaces 598 that protrude away from each other. The rounded outer surfaces 598 can be configured to be received by the groove 554 of a respective socket 552 when the contact mating ends are mated with the interposer mating ends. It should be appreciated, however, that the rounded outer surfaces 598 can be a continuous rounded protrusion that extends radially around the pin or a series of partial spherical portions, as desired.

It should be appreciated that any of the disclosed systems can be included in an assembly that includes the first and second electrical components. Furthermore, any of the disclosed electrical contacts and interposers can be sold alone or in combination with any of the other electrical contacts and interposers. Therefore, the systems can include any of the disclosed first electrical contacts, any of the disclosed second electrical contacts, and any of the disclosed interposers either alone or in combination.

While the foregoing description and drawings represent the preferred embodiment of the present invention, it will be understood that various additions, modifications, combinations and/or substitutions may be made therein without departing from the spirit and scope of the invention as defined in the accompanying claims. In particular, it will be clear to those skilled in the art that the invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components, which are particularly adapted to specific environments and operative requirements without departing from the principles of the invention. In addition, features described herein may be used singularly or in combination with other features. For example, features described in connection with one component may be used and/or interchanged with features described in another component. The presently disclosed embodiment is therefore to be considered in all respects as illustrative and not restrictive, the scope of the invention being indicated by the appended claims, and not limited to the foregoing description.

It will be appreciated by those skilled in the art that various modifications and alterations of the invention can be made without departing from the broad scope of the appended claims. Some of these have been discussed above and others will be apparent to those skilled in the art.

1. An electrical connector system comprising:
a first electrically conductive contact having a first contact body, a first contact mating end that extends from the first contact body, and a first contact mounting end that extends from the first contact body, the first contact mounting end configured to be electrically connected to a first complementary electrical component, and;
an interposer having a first interposer mating end and a second interposer end opposite the first interposer mating end, the second interposer end configured to be placed in electrical communication with a second complementary electrical component,
wherein the first electrically conductive contact is configured to mate at its first contact mating end to the first interposer mating end so as to place the first electrically conductive contact in electrical communication with the interposer, the first electrically conductive contact being pivotable relative to the interposer when the first electrically conductive contact and interposer are in electrical communication with each other.

2. The electrical connector system of claim 1, wherein the first interposer mating end defines a first socket.

3. The electrical connector system of claim 2, wherein the first contact mating end is compressible, such that the first contact mating end compresses as it is received in the first socket and expands after the socket receives the first contact mating end.

4. The electrical connector system of claim 3, wherein the first contact mating end has a round outer surface.

5. The electrical connector system of claim 2, wherein the first contact mating end is translatable in the first socket relative to the interposer along a direction of translation toward and away from the second interposer end.

6. The electrical connector system of claim 5, wherein the first contact body defines a stop surface aligned with the first interposer mating end along the direction of translation, such that the stop surface is configured to abut the first interposer mating end so as to limit translation of the first contact mating end with respect to the interposer toward the second interposer end, and abutment of the stop surface and the first interposer mating end prevents translation of the first contact mating end with respect to the interposer toward the second interposer end.

7. (canceled)

8. The electrical connector system of claim 2, wherein the first contact mating end defines first and second cantilevered beams, and wherein at least one or both of the first and second cantilevered beams compresses toward the other of the first and second cantilevered beams as the first contact mating end is inserted into the first socket.

9. The electrical connector system of claim 8, wherein at least one or both of the first and second cantilevered beams defines a rounded outer surface.

10. (canceled)

11. The electrical connector system of claim 1, wherein the first electrically conductive contact further comprises a spring element connected between the first contact body and the first contact mating end.

12. The electrical connector system of claim 11, wherein the spring (i) is resiliently compressible as the first contact mating end translates toward the first contact body, and (ii) is resiliently extendable as the first contact mating end translates toward the second interposer end in the first socket.

13-15. (canceled)

16. The electrical connector system of claim 1, wherein the interposer defines a sleeve.

17. The electrical connector system of claim 16, wherein, the first interposer mating end includes a plurality of flexible fingers that are configured to flex as the first contact mating end is received by the first interposer mating end.

18. (canceled)

19. The electrical connector system of claim 1, wherein the first interposer mating end defines a ball joint.

20. (canceled)

21. The electrical connector system of claim 1, further comprising a second electrically conductive contact having a second body, a second contact mating end that extends from the second body, and a second contact mounting end that extends from the second body, the second contact mounting end configured to be electrically connected to the second complementary electrical component, wherein the second electrically conductive contact is configured to mate at its second contact mating end to the second interposer end so as to place the first electrically conductive contact in electrical communication with the second electrically conductive contact through the interposer, the second electrically conductive contact being pivotable relative to the interposer when the second electrically conductive contact and interposer are in electrical communication with each other.

22. The electrical connector system of claim 21, wherein the second interposer mating end defines a second socket.

23. An interposer configured to place first and second electrically conductive contacts in electrical communication with each other, the interposer comprising:
an interposer body that is elongate along a first direction, the interposer body including a first interposer mating end and a second interposer mating end that is spaced from the first interposer mating end along the first direction,
wherein (i) the first interposer mating end defines a first socket that is configured to receive a first mating end of the first electrically conductive contact along the first direction such that the first electrically conductive contact is pivotable relative to the interposer body, and (ii) the second interposer mating end defines a second socket that is configured to receive a second mating end of the second electrically conductive contact along a second direction that is opposite the first direction such that the second electrically conductive contact is pivotable relative to the interposer body.

24. The interposer of claim 23, wherein the first interposer mating end is oriented substantially parallel with respect to the second interposer mating end.

25. The interposer of claim 23, wherein the interposer body defines a sleeve.

26. The interposer of claim 23, wherein (i) the first interposer mating end includes a plurality of flexible fingers that are configured to flex as the first contact mating end is received by the first interposer mating end, and (ii) the second interposer mating end includes a plurality of flexible fingers that are configured to flex as the second contact mating end is received by the second interposer mating end.

27. The interposer of claim 26, wherein each flexible finger flares radially outward at its end.

28-34. (canceled)
